(19) United States
(12) Patent Application Publication
(10) Pub. No.: US 2026/0124788 A1
(43) Pub. Date: May 7, 2026

(54) METHOD AND SYSTEM FOR DETECTING COMPLETION OF INGOT SLICING PROCESS

(71) Applicant: Industrial Technology Research Institute, Hsinchu (TW)

(72) Inventors: CHIH-YU KE, Pingtung County (TW); Kun-Wei Lin, Tainan-City (TW); Tung-Ying Lin, Kaohsiung City (TW)

(21) Appl. No.: 19/361,188

(22) Filed: Oct. 17, 2025

(30) Foreign Application Priority Data
Nov. 5, 2024 (TW) 113142247

(51) Int. Cl. B28D 5/00; B23K 26/53; B23K 103/00; G01N 21/95; G06T 7/00

(52) U.S. Cl. CPC B28D 5/0011; B28D 5/0052; G01N 21/9505; G06T 7/0004; B23K 26/53; B23K 2103/56; G06T 2207/30148

(57) ABSTRACT

A system and method for detecting completion of ingot slicing process are provided. The method includes: holding an ingot's top and bottom surfaces with upper and lower suction cups; applying a pulling force via the upper suction cup with a load cell while an ultrasonic source vibrates the ingot; turning off the ultrasonic source when the pulling force is below a set value; performing an abnormality handling process if vacuum is not maintained between the upper suction cup and wafer or between the lower suction cup and ingot bottom, or if vacuum pressure detected by a negative pressure proportional regulator valve is below a threshold value; releasing the wafer onto a receiving tray; performing the abnormality handling process if cracks on the surface of the wafer is detected; and performing the abnormality handling process if the space between a fork suction cup and the wafer is not kept vacuum.

### CROSS REFERENCE TO RELATED APPLICATION

This application also claims priority to Taiwan Patent Application No. 113142247 filed in the Taiwan Patent Office on Nov. 5, 2024, the entire content of which is incorporated herein by reference.

### TECHNICAL FIELD

The present disclosure relates to a wafer process-related technology related to wafer, in particular to a method for detecting completion of ingot slicing process and the system thereof.

### BACKGROUND

In semiconductor processes, the procedure of separating a wafer from an ingot is referred to as “slicing.” A slicing machine is used to separate and remove a wafer from the surface of an ingot that has undergone laser modification and contains discontinuous invisible cracks.

Currently available slicing methods adopt a diamond wire cutting process and an ultrasonic wet process. In the wet process, the ingot is placed in a liquid having a specific temperature (for example, water), with the liquid serving as a medium, and the wafer is separated from the ingot by means of acoustic wave vibration.

However, the diamond wire cutting process suffers from higher material loss and slower cutting speed. The cutting process results in a material loss of approximately 260 μm. Considering a wafer thickness of 350 μm, this translates to almost one entire wafer being wasted per cut. Furthermore, the surface of the wafer after separation is rough, requiring subsequent surface machining and grinding.

Accordingly, a technical approach for slicing by using laser light in combination with ultrasonic vibration and suction cups is developed. Laser light is used to form a modified layer with cracks inside the ingot, and in conjunction with ultrasonic vibration and the suction force applied by the suction cups, a fragment (i.e., the wafer) formed by the cracks extending from the modified layer is separated from the ingot.

Compared with diamond wire cutting, laser modification can increase the number of wafers obtained. For example, if the thickness of the ingot is 20,000 μm and wafers of 350 μm thickness are to be cut, the material loss per wafer by diamond wire cutting is 260 μm, while the material loss per wafer by laser modification is 80 μm. Diamond wire cutting can produce 32 wafers, whereas laser modification can produce 46 wafers.

Although the slicing method using laser light in combination with ultrasonic vibration and suction cups is faster and involves lower material loss, improper coordination between the ultrasonic vibration and the suction cups often results in wafers being fractured by the ultrasonic vibration.

In addition, in the process of separating the wafer from the ingot using suction cups, opposite upper and lower suction cups respectively act on the wafer and the ingot by suction. If the vacuum degree between the suction cups and the wafer and ingot is not properly controlled, the wafer is prone to cracking during the separation process.

Furthermore, during the process of transferring the wafer to a cassette, for example, when the wafer held by a suction cup is released onto a receiving tray, or when the wafer is transferred by a fork, the fragile wafer is easily broken.

Accordingly, it has become an important issue to provide a “method and system for detecting completion of ingot slicing process” capable of confirming that the slicing process of a wafer is successful and the wafer does not crack.

### SUMMARY

One embodiment of the disclosure provides a method for detecting completion of ingot slicing process. The method is performed by a controller and includes the following steps: controlling an upper suction cup and a lower suction cup to respectively hold the top surface and the bottom surface of the ingot, wherein the upper suction cup is connected to an ultrasonic source and is provided with a load cell, the upper suction cup applies a pulling force in the direction away from the ingot to the top surface while the ultrasonic source generate ultrasonic waves to vibrate the ingot, and the pulling force applied by the upper suction cup to the top surface is detected by the load cell; controlling the load cell to detect whether the pulling force applied by the upper suction cup to the top surface is less than a set value; if yes, the ultrasonic source is turned off, and the upper suction cup holds a wafer separated from the ingot; if no, returning to the previous step; controlling an upper vacuum pressure gauge and a lower vacuum pressure gauge to respectively detect whether the space between the upper suction cup and the wafer, and the space between the lower suction cup and the bottom surface of the ingot are kept under vacuum; if yes, proceeding to the next step; if no, an abnormality handling process is performed; controlling a negative pressure proportional regulator valve to detect whether the vacuum pressure between the upper suction cup and the wafer is less than a threshold value, wherein if yes, the abnormality handling process is performed; if no, proceeding to the next step; turning off the upper suction cup to release the wafer onto a receiving tray, and detecting, by a photoelectric proximity sensor, whether the surface of the wafer is cracked, wherein if yes, the abnormality handling process is performed; if no, proceeding to the next step; and controlling a fork suction cup to hold the wafer from the receiving tray, and detecting, by a fork vacuum pressure gauge, whether the space between the fork suction cup and the wafer is kept under vacuum; if no, the abnormality handling process is performed; if yes, the wafer is moved out of the receiving tray by the fork suction cup.

Another embodiment of the disclosure provides a system for detecting completion of ingot slicing process. The system includes a slicing device, a load cell, an upper vacuum pressure gauge, a lower vacuum pressure gauge, a negative pressure proportional regulator valve, a receiving tray, a photoelectric proximity sensor, a fork suction cup, a fork vacuum pressure gauge and a controller. The slicing device includes an upper suction cup and a lower suction cup. The upper suction cup is connected to an ultrasonic source. The upper suction cup and the lower suction cup respectively hold the top surface and the bottom surface of the ingot. The upper suction cup applies a pulling force in the direction away from the ingot to the top surface, while the ultrasonic source generates ultrasonic waves to vibrate the ingot. The load cell is connected to the upper suction cup and detects the pulling force applied by the upper suction cup to the top surface. The upper vacuum pressure gauge is connected to the upper suction cup, and detects the vacuum degree between the upper suction cup and the top surface. The lower vacuum pressure gauge is connected to the lower suction cup, and detects the vacuum degree between the lower suction cup and the bottom surface. The negative pressure proportional regulator valve is connected to the upper suction cup, and detects the vacuum pressure between the upper suction cup and the wafer. The receiving tray is movably disposed below the upper suction cup, and receives the wafer held by the upper suction cup. The photoelectric proximity sensor is connected to the receiving tray, and detects whether the surface of the wafer on the receiving tray is cracked. The fork suction cup is movably disposed on one side of the receiving tray, and holds the wafer from the receiving tray to move the wafer out of the receiving tray. The fork vacuum pressure gauge is connected to the fork suction cup, and detects the vacuum degree between the fork suction cup and the wafer. The controller is electrically connected to and control aforementioned components.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of a system for detecting completion of ingot slicing process in accordance with one embodiment of the disclosure.

FIG. 2 is a flow chart of a method for detecting completion of ingot slicing process in accordance with one embodiment of the disclosure.

FIG. 3 is a schematic view of a system for detecting completion of ingot slicing process in accordance with another embodiment of the disclosure.

FIG. 4 is a flow chart of a method for detecting completion of ingot slicing process in accordance with another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

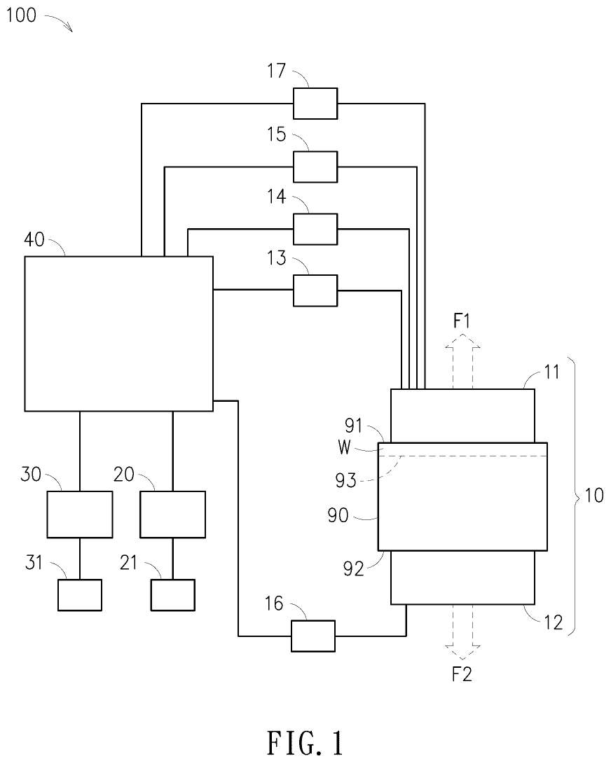

Please refer to FIG. 1, which is a schematic view of a system for detecting completion of ingot slicing process in accordance with one embodiment of the disclosure. The ingot slicing device 100 of the disclosure includes a slicing device 10, a load cell 14, an upper vacuum pressure gauge 15, a lower vacuum pressure gauge 16, a negative pressure proportional regulator valve 17, a receiving tray 20, a photoelectric proximity sensor 21, a fork suction cup 30, a fork vacuum pressure gauge 31, and a controller 40.

The controller 40 is electrically connected to and controls the operations of the slicing device 10, the load cell 14, the upper vacuum pressure gauge 15, the lower vacuum pressure gauge 16, the negative pressure proportional regulator valve 17, the receiving tray 20, the photoelectric proximity sensor 21, the fork suction cup 30, and the fork vacuum pressure gauge 31. Generally speaking, the controller 40 includes a human-machine interface and a central-processing unit or a programmable micro control unit or microprocessor, but is not limited thereto.

The slicing device 10 includes an upper suction cup 11 and a lower suction cup 12. The upper suction cup 11 is connected to an ultrasonic source 13. The upper suction cup 11 and the lower suction cup 12 respectively hold the top surface 91 and the bottom surface 92 of an ingot 90. The upper suction cup 11 applies a pulling force F1 to the top surface 91 in the direction away from the ingot 90, while the ultrasonic source 13 generates ultrasonic waves to vibrate the ingot 90.

Depending on actual needs, the lower suction cup 12 may simultaneously apply a pulling force F2 to the bottom surface 92 of the ingot 90 in the direction away from the ingot 90, with the pulling forces F1 and F2 opposing each other. Alternatively, the lower suction cup 12 may apply a clamping force or gripping force to the bottom surface 92 of the ingot 90.

By applying the pulling forces F1 and F2 to the ingot 90 and generating ultrasonic waves to vibrate the ingot 90 via the ultrasonic source 13, the ingot 90 can be split into two along its plane to be sliced 93. The wafer W separated from the ingot 90 is held by the upper suction cup 11, while the lower suction cup 12 continues to hold the bottom surface 92 of the ingot 90.

It should be noted that the plane to be sliced 93 is, for example, formed by scanning a laser beam generated from a laser source, which is focused at a fixed depth within the ingot to form a modified layer and cracks. The focal position of the laser beam within the ingot is set as required.

In general, the ingot 90 may be a silicon carbide (SiC) ingot, but is not limited thereto.

Please refer to FIG. 1. The load cell 14 is connected to the upper suction cup 11 for detecting the pulling force F1 applied by the upper suction cup 11 to the top surface 91.

The upper vacuum pressure gauge 15 is connected to the upper suction cup 11 for detecting the vacuum degree between the upper suction cup 11 and the top surface 91.

The lower vacuum pressure gauge 16 is connected to the lower suction cup 12 for detecting the vacuum degree between the lower suction cup 12 and the bottom surface 92.

The negative pressure proportional regulator valve 17 is connected to the upper suction cup 11 for detecting the vacuum pressure between the upper suction cup 11 and the wafer W, thereby determining whether cracks are present on the surface of the wafer W.

The receiving tray 20 is movably disposed below the upper suction cup 11 for receiving the wafer W held by the upper suction cup 11.

In general, after the ingot 90 is split into two along its plane to be sliced 93, the upper suction cup 11 holds the wafer W and then ascends, after which the receiving tray 20 is moved below the upper suction cup 11.

The photoelectric proximity sensor 21 is connected to the receiving tray 20 for detecting whether the surface of the wafer W on the receiving tray 20 is cracked.

The fork suction cup 30 is movably disposed at one side of the receiving tray 20 for holding the wafer W on the receiving tray 20 and transferring the wafer W out of the receiving tray 20.

The fork vacuum pressure gauge 31 is connected to the fork suction cup 30 for detecting the vacuum degree between the fork suction cup 30 and the wafer W.

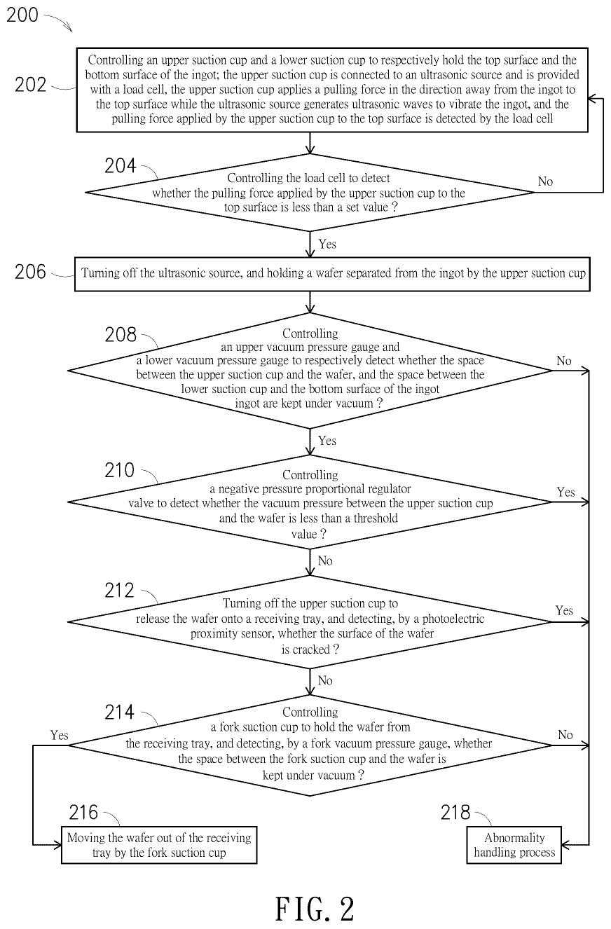

Please refer to FIG. 1 and FIG. 2. FIG. 2 is a flow chart of a method for detecting completion of ingot slicing process in accordance with one embodiment of the disclosure. FIG. 2 illustrates the process 200 of the method, which includes the following steps.

Step 202: controlling an upper suction cup 11 and a lower suction cup 12 to respectively hold the top surface 91 and the bottom surface 92 of the ingot 90; the upper suction cup 11 is connected to an ultrasonic source 13 and is provided with a load cell 14, the upper suction cup 11 applies a pulling force F1 in the direction away from the ingot 90 to the top surface 91 while the ultrasonic source 13 generate ultrasonic waves to vibrate the ingot 90, and the pulling force F1 applied by the upper suction cup 11 to the top surface 91 is detected by the load cell 14.

Step 204: controlling the load cell 14 to detect whether the pulling force applied by the upper suction cup 11 to the top surface 91 is less than a set value; if yes, the process proceeds to the next step; if no, the process returns to the previous step. The set value may be preset to zero, for example.

When the load cell 14 detects that the pulling force F1 applied by the upper suction cup 11 to the top surface 91 is less than the set value, it indicates that the upper suction cup 11 may have separated the wafer W from the ingot 90.

Step 206: turning off the ultrasonic source 13, and holding a wafer W separated from the ingot 90 by the upper suction cup 11.

When the load cell 14 detects that the pulling force F1 applied by the upper suction cup 11 to the top surface 91 is less than the set value, it is necessary to control the ultrasonic source 13 to stop the ultrasonic vibration to prevent continuous vibration from causing the wafer W to break.

Step 208: controlling an upper vacuum pressure gauge 15 and a lower vacuum pressure gauge 16 to respectively detect whether the space between the upper suction cup 11 and the wafer W, and the space between the lower suction cup 12 and the bottom surface 92 of the ingot 90 are kept under vacuum; if yes, proceeding to the next step; if no, the abnormality handling process if Step 218 is performed.

When the upper vacuum pressure gauge 15 and the lower vacuum pressure gauge 16 respectively detect that the space between the upper suction cup 11 and the wafer W, and the space between the lower suction cup 12 and the bottom surface 92 of the ingot 90 are kept vacuum, it indicates that the wafer W has been normally separated from the ingot 90; otherwise, the wafer W may not have been completely separated from the ingot 90.

Step 210: controlling a negative pressure proportional regulator valve 17 to detect whether the vacuum pressure between the upper suction cup 11 and the wafer W is less than a threshold value, wherein if yes, the abnormality handling process of Step 218 is performed; if no, the process proceeds to the next step. The threshold value can be set according to actual needs; for example, the threshold value may be set as 80% of a preset vacuum pressure value.

When the negative pressure proportional regulator valve 17 detects that the vacuum pressure between the upper suction cup 11 and the wafer W is less than the threshold value, it indicates that the wafer W has cracks, resulting in a non-vacuum condition between the upper suction cup 11 and the wafer W.

Step 212: turning off the upper suction cup 11 to release the wafer W onto a receiving tray 20, and detecting, by a photoelectric proximity sensor 21, whether the surface of the wafer W is cracked, wherein if yes, the abnormality handling process of Step 218 is performed; if no, the process proceeds to the next step.

The photoelectric proximity sensor 21 can detect the surface of the wafer W to determine whether the surface of the wafer W is cracked.

Step 214: controlling a fork suction cup 30 to hold the wafer W from the receiving tray 20, and detecting, by a fork vacuum pressure gauge 31, whether the space between the fork suction cup 30 and the wafer W is kept under vacuum; if no, the abnormality handling process of Step 218 is performed; if yes, the process proceeds to the next step.

When the fork vacuum pressure gauge 31 detects that the space between the fork suction cup 30 and the wafer W is kept vacuum, it indicates that the wafer W is free from warpage or deformation.

Step 216: moving the wafer W out of the receiving tray 20 by the fork suction cup 30.

Subsequently, the wafer W may be transferred to a storage device such as a cassette for storage.

In the process 200 of the method for completion of ingot slicing process according to the disclosure, the operations of each component in Steps 202 to 218 are controlled by the controller 40.

With respect to the abnormality handling process of Step 218, for example, an alarm may be used to issue an abnormality alert, after which a technician may intervene to perform manual processing. However, the disclosure is not limited thereto.

For example, in Step 208, if the upper vacuum pressure gauge 15 detects a non-vacuum condition between the upper suction cup 11 and the wafer W, or in Step 210, if the negative pressure proportional regulator valve 17 detects that the vacuum pressure between the upper suction cup 11 and the wafer W is less than the threshold value, then the machine is shut down and the technician intervenes for inspection. Similarly, in Step 212, if the photoelectric proximity sensor 21 detects cracks on the surface of the wafer W, or in Step 214, if the fork vacuum pressure gauge 31 detects a non-vacuum condition between the fork suction cup 30 and the wafer W, the machine is also shut down and the technician intervenes for inspection. In general, the causes of the above abnormalities may include incomplete separation of the wafer W, the presence of cracks, or wafer breakage. After shutdown and the technician intervenes, the abnormal wafer W can be removed from the machine, after which the machine can be restarted to continue subsequent steps.

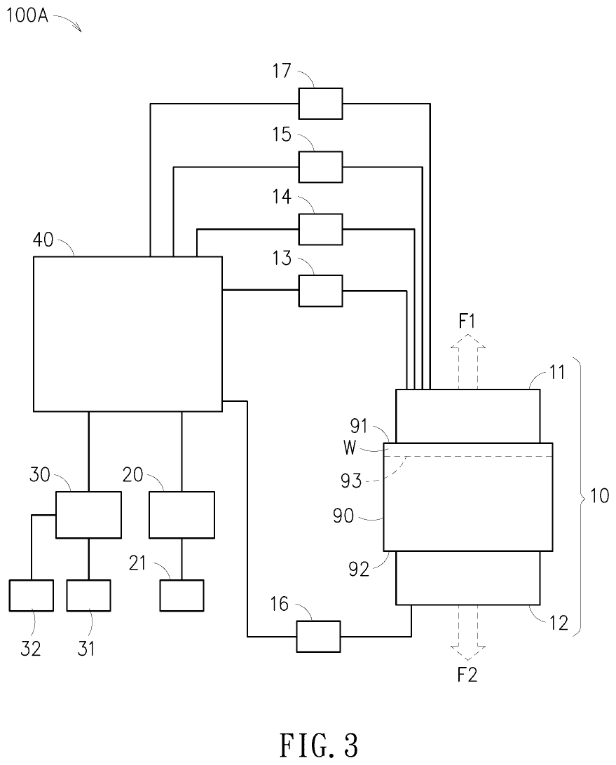

Please refer to the embodiment shown in FIG. 3. The ingot slicing device 100A of this embodiment includes a slicing device 10, a load cell 14, an upper vacuum pressure gauge 15, a lower vacuum pressure gauge 16, a negative pressure proportional regulator valve 17, a receiving tray 20, a photoelectric proximity sensor 21, a fork suction cup 30, a fork vacuum pressure gauge 31, an image capture device 32, and a controller 40.

The main difference between the embodiment of FIG. 3 and the embodiment of FIG. 1 lies in that the fork suction cup 30 of the embodiment of FIG. 3 is further connected to an image capture device 32, which captures at least one image of the wafer W to determine whether the contour of the wafer W is complete.

For example, the image capture device 32 may be a charge-coupled device (CCD) for capturing the image of the top surface 91 of the wafer W, the image of the entire periphery of the side surface of the wafer W, and three-dimensional images of the wafer W at different angles. The above images may be static and/or dynamic images, such as photographs and/or videos.

Subsequently, the controller 40 determines whether the surface of the wafer W is cracked based on the captured images, and simultaneously determines whether the wafer W is warped based on the image of the entire periphery of the side surface of the wafer W.

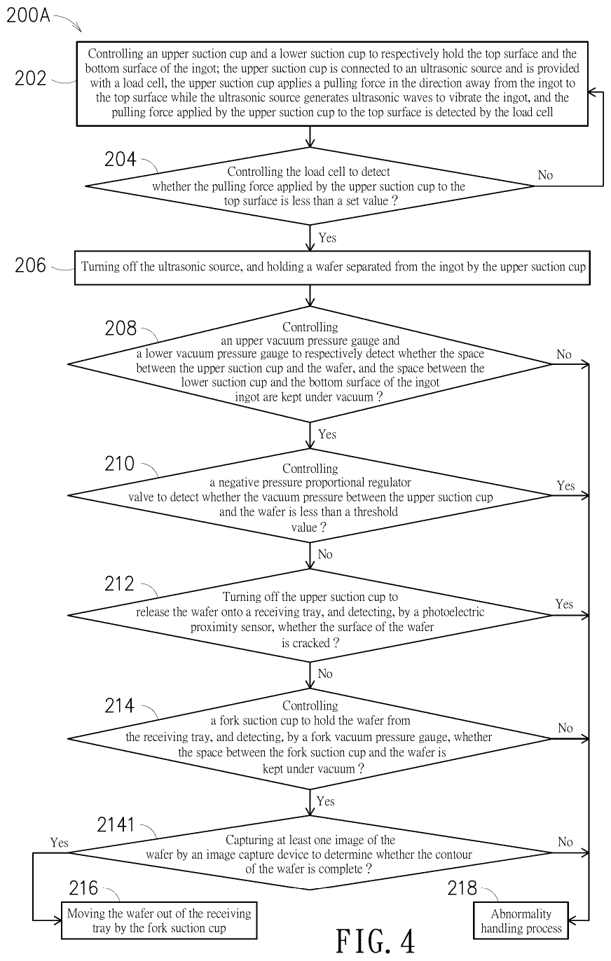

Please refer to FIG. 3 and FIG. 4. Based on the configuration shown in FIG. 3, the process 200A of the method for completion of ingot slicing process of FIG. 4 may include the following steps:

Step 202: controlling an upper suction cup 11 and a lower suction cup 12 to respectively hold the top surface 91 and the bottom surface 92 of the ingot 90; the upper suction cup 11 is connected to an ultrasonic source 13 and is provided with a load cell 14, the upper suction cup 11 applies a pulling force F1 in the direction away from the ingot 90 to the top surface 91 while the ultrasonic source 13 generate ultrasonic waves to vibrate the ingot 90, and the pulling force F1 applied by the upper suction cup 11 to the top surface 91 is detected by the load cell 14.

Step 204: controlling the load cell 14 to detect whether the pulling force applied by the upper suction cup 11 to the top surface 91 is less than a set value; if yes, the process proceeds to the next step; if no, the process returns to the previous step. The set value may be preset to zero, for example.

When the load cell 14 detects that the pulling force F1 applied by the upper suction cup 11 to the top surface 91 is less than the set value, it indicates that the upper suction cup 11 may have separated the wafer W from the ingot 90.

Step 206: turning off the ultrasonic source 13, and holding a wafer W separated from the ingot 90 by the upper suction cup 11.

When the load cell 14 detects that the pulling force F1 applied by the upper suction cup 11 to the top surface 91 is less than the set value, it is necessary to control the ultrasonic source 13 to stop the ultrasonic vibration to prevent continuous vibration from causing the wafer W to break.

Step 208: controlling an upper vacuum pressure gauge 15 and a lower vacuum pressure gauge 16 to respectively detect whether the space between the upper suction cup 11 and the wafer W, and the space between the lower suction cup 12 and the bottom surface 92 of the ingot 90 are kept under vacuum; if yes, proceeding to the next step; if no, the abnormality handling process if Step 218 is performed.

When the upper vacuum pressure gauge 15 and the lower vacuum pressure gauge 16 respectively detect that the space between the upper suction cup 11 and the wafer W, and the space between the lower suction cup 12 and the bottom surface 92 of the ingot 90 are kept vacuum, it indicates that the wafer W has been normally separated from the ingot 90; otherwise, the wafer W may not have been completely separated from the ingot 90.

Step 210: controlling a negative pressure proportional regulator valve 17 to detect whether the vacuum pressure between the upper suction cup 11 and the wafer W is less than a threshold value, wherein if yes, the abnormality handling process of Step 218 is performed; if no, the process proceeds to the next step. The threshold value can be set according to actual needs; for example, the threshold value may be set as 80% of a preset vacuum pressure value.

When the negative pressure proportional regulator valve 17 detects that the vacuum pressure between the upper suction cup 11 and the wafer W is less than the threshold value, it indicates that the wafer W has cracks, resulting in a non-vacuum condition between the upper suction cup 11 and the wafer W.

Step 212: turning off the upper suction cup 11 to release the wafer W onto a receiving tray 20, and detecting, by a photoelectric proximity sensor 21, whether the surface of the wafer W is cracked, wherein if yes, the abnormality handling process of Step 218 is performed; if no, the process proceeds to the next step.

The photoelectric proximity sensor 21 can detect the surface of the wafer W to determine whether the surface of the wafer W is cracked.

Step 214: controlling a fork suction cup 30 to hold the wafer W from the receiving tray 20, and detecting, by a fork vacuum pressure gauge 31, whether the space between the fork suction cup 30 and the wafer W is kept under vacuum; if no, the abnormality handling process of Step 218 is performed; if yes, the process proceeds to the next step.

When the fork vacuum pressure gauge 31 detects that the space between the fork suction cup 30 and the wafer W is kept vacuum, it indicates that the wafer W is free from warpage or deformation.

Step 2141: capturing at least one image of the wafer W by an image capture device 32 to determine whether the contour of the wafer W is complete; if no, the abnormality handling process is performed; if yes, the process proceeds to the next step.

Step 216: moving the wafer W out of the receiving tray 20 by the fork suction cup 30.

Subsequently, the wafer W may be transferred to a storage device such as a cassette for storage.

In the process 200A of the method for completion of ingot slicing process according to the disclosure, the operations of each component in Steps 202 to 218 are controlled by the controller 40.

In summary, the method and system for completion of ingot slicing process provided by the present disclosure can make sure that the ingot slicing process is successful, that is, the wafer and the ingot are successfully separated, and can ensure that the wafer is free from breakage. Afterward, the wafer can be transferred into a storage device such as a cassette for storage.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for detecting completion of ingot slicing process, performed by a controller for detecting an ingot when the ingot undergoes an ultrasonic slicing process after the ingot is laser-modified, wherein the method comprises:
controlling an upper suction cup and a lower suction cup to respectively hold a top surface and a bottom surface of the ingot, wherein the upper suction cup is connected to an ultrasonic source and is provided with a load cell, the upper suction cup applies a pulling force in a direction away from the ingot to the top surface while the ultrasonic source generate ultrasonic waves to vibrate the ingot, and the pulling force applied by the upper suction cup to the top surface is detected by the load cell;
controlling the load cell to detect whether the pulling force applied by the upper suction cup to the top surface is less than a set value; if yes, the ultrasonic source is turned off, and the upper suction cup holds a wafer separated from the ingot; if no, returning to the previous step;
controlling an upper vacuum pressure gauge and a lower vacuum pressure gauge to respectively detect whether a space between the upper suction cup and the wafer, and a space between the lower suction cup and the bottom surface of the ingot are kept under vacuum; if yes, proceeding to the next step; if no, an abnormality handling process is performed;
controlling a negative pressure proportional regulator valve to detect whether a vacuum pressure between the upper suction cup and the wafer is less than a threshold value, wherein if yes, the abnormality handling process is performed; if no, proceeding to the next step;
turning off the upper suction cup to release the wafer onto a receiving tray, and detecting, by a photoelectric proximity sensor, whether a surface of the wafer is cracked, wherein if yes, the abnormality handling process is performed; if no, proceeding to the next step; and
controlling a fork suction cup to hold the wafer from the receiving tray, and detecting, by a fork vacuum pressure gauge, whether a space between the fork suction cup and the wafer is kept under vacuum; if no, the abnormality handling process is performed; if yes, the wafer is moved out of the receiving tray by the fork suction cup.

2. The method for detecting completion of ingot slicing process as claimed in claim 1, wherein the threshold value is 80% of a preset vacuum pressure value.

3. The method for detecting completion of ingot slicing process as claimed in claim 1, wherein the fork suction cup is further connected to an image capture device, and at least one image of the wafer is captured by the image capture device to determine whether a contour of the wafer is complete; if no, the abnormality handling process is performed; if yes, the wafer is moved out of the receiving tray by the fork suction cup.

4. The method for detecting completion of ingot slicing process as claimed in claim 3, wherein the image comprises static and/or dynamic images.

5. The method for detecting completion of ingot slicing process as claimed in claim 1, wherein the abnormality handling process comprises issuing an abnormality alert.

6. The method for detecting completion of ingot slicing process as claimed in claim 1, wherein the controller comprises a human-machine interface and a central-processing unit or a programmable micro control unit, or a programmable microprocessor.

7. The method for detecting completion of ingot slicing process as claimed in claim 1, wherein the set value is zero.

8. A system for detecting completion of ingot slicing process, connected to an ultrasonic slicing machine to separate a wafer from an ingot, and comprising:
a slicing device comprising an upper suction cup and a lower suction cup, wherein the upper suction cup is connected to an ultrasonic source, and the upper suction cup and the lower suction cup are configured to respectively hold a top surface and a bottom surface of the ingot, and the upper suction cup is configured to apply a pulling force in a direction away from the ingot to the top surface, while the ultrasonic source is configured to generate ultrasonic waves to vibrate the ingot;
a load cell connected to the upper suction cup and configured to detect the pulling force applied by the upper suction cup to the top surface;
an upper vacuum pressure gauge connected to the upper suction cup, and configured to detect a vacuum degree between the upper suction cup and the top surface;
a lower vacuum pressure gauge connected to the lower suction cup, and configured to detect a vacuum degree between the lower suction cup and the bottom surface;
a negative pressure proportional regulator valve connected to the upper suction cup, and configured to detect a vacuum pressure between the upper suction cup and the wafer;
a receiving tray movably disposed below the upper suction cup, and configured to receive the wafer held by the upper suction cup;
a photoelectric proximity sensor connected to the receiving tray, and configured to detect whether a surface of the wafer on the receiving tray is cracked;
a fork suction cup movably disposed on one side of the receiving tray, and configured to hold the wafer from the receiving tray to move the wafer out of the receiving tray;
a fork vacuum pressure gauge connected to the fork suction cup, and configured to detect a vacuum degree between the fork suction cup and the wafer; and
a controller electrically connected to and configured to control aforementioned components.

9. The system for detecting completion of ingot slicing process as claimed in claim 8, further comprising an image capture device is connected to the fork suction cup, and an image of the wafer is captured by the image capture device to determine whether a contour of the wafer is complete.

10. The system for detecting completion of ingot slicing process as claimed in claim 8, wherein the controller comprises a human-machine interface and a central processing unit or a programmable micro control unit, or a programmable microprocessor.
